(19) United States
(12) Patent Application Publication
(10) Pub. No.: US 2026/0310354 A1
(43) Pub. Date: Oct. 8, 2026

(54) METHOD FOR MANAGING MULTI-LEVEL DISAGGREGATED MEMORY AND APPARATUS FOR THE SAME

(71) Applicant: Electronics and Telecommunications Research Institute, Daejeon (KR)

(72) Inventors: Yeon Jeong JEONG, Daejeon (KR); Kwang Won KOH, Daejeon (KR); Chang Dae KIM, Daejeon (KR); Tae Hoon KIM, Daejeon (KR); Eun Ji PAK, Daejeon (KR); Kang Ho KIM, Daejeon (KR)

(73) Assignee: Electronics and Telecommunications Research Institute, Daejeon (KR)

(21) Appl. No.: 19/576,044

(22) Filed: Mar. 24, 2026

(30) Foreign Application Priority Data
Apr. 8, 2025 (KR) 10-2025-0045091

(51) Int. Cl. G06F 3/06

(52) U.S. Cl. CPC G06F 3/0611; G06F 3/0631; G06F 3/067

(57) ABSTRACT

The present disclosure relates to a method for managing a multi-level disaggregated memory and an apparatus for the same. A multi-level disaggregated memory management method according to an embodiment of the present disclosure may include obtaining a memory access pattern based on a comeback interval for each of at least one memory page; and storing the at least one memory page in at least one remote memory group based on the memory access pattern.

### BACKGROUND

The present disclosure relates to memory management, and more specifically, relates to a method for managing a multi-level disaggregated memory and an apparatus for the same.

With the recent development of memory-related technologies, it has become possible to realize a multi-level disaggregated memory structure. For example, as a high-speed interconnect technology has been introduced, data transmission speed between a memory and a central processing unit (CPU) has significantly increased, enabling the efficient management and transfer of multi-level memory data between local and remote and the integrated management of various memory hierarchies.

Aside from supporting a multi-level memory hierarchy, there are numerous technical barriers to effectively implement it. For example, it is necessary to minimize latency required for data transmission and reception between memory layers. Particularly, a delay in data transmission and reception between a remote memory and a local memory may cause a bottleneck, thereby degrading overall system performance. Accordingly, a new method is required to optimize various memory layers while minimizing latency.

### SUMMARY

The present disclosure is to provide a method and an apparatus for optimizing an arrangement for memory layers based on a time interval until a memory page is accessed again and/or a pattern thereof in multi-level disaggregated memory management.

The technical objects to be achieved by the present disclosure are not limited to the above-described technical objects, and other technical objects which are not described herein will be clearly understood by those skilled in the pertinent art from the following description.

A multi-level disaggregated memory management method according to an embodiment of the present disclosure may include obtaining a memory access pattern based on a comeback interval for each of at least one memory page; and storing the at least one memory page in at least one remote memory group based on the memory access pattern.

A multi-level disaggregated memory management apparatus according to an additional embodiment of the present disclosure may include at least one transceiver; at least one system interface; and at least one processor. The at least one processor may be configured to obtain a memory access pattern based on a comeback interval for each of at least one memory page; and transmit, through the at least one transceiver, the at least one memory page to be stored in at least one remote memory group based on the memory access pattern.

A processing unit for managing a multi-level disaggregated memory according to an additional embodiment of the present disclosure may include at least one processor; and at least one local memory operably connected to the at least one processor, and based on being executed by the at least one processor, storing instructions for performing an operation for obtaining a memory access pattern based on a comeback interval for each of at least one memory page; and an operation for allocating the at least one memory page to at least one remote memory group based on the memory access pattern.

In an least one non-transitory computer-readable medium for storing at least one instruction according to an additional embodiment of the present disclosure, the at least one instruction may control an apparatus to perform an operation for obtaining a memory access pattern based on a comeback interval for each of at least one memory page; and an operation for allocating the at least one memory page to at least one remote memory group based on the memory access pattern by being executed by at least one processor.

In some embodiments of the present disclosure, the comeback interval may correspond to a time interval from a time point when a specific memory page is evicted to a remote memory group to a time point when the specific memory page is accessed.

In some embodiments of the present disclosure, the memory access pattern may be determined based on a histogram for a comeback interval for each of the at least one memory page.

In some embodiments of the present disclosure, the remote memory group may include one remote memory or a plurality of remote memories, and a group identifier (ID) corresponding to an access speed rank may be allocated to each of the remote memory groups.

In some embodiments of the present disclosure, when access occurs to a specific memory page among at least one memory page, a comeback interval for the specific memory page may be updated.

In some embodiments of the present disclosure, a specific memory page determined to correspond to a remote memory group corresponding to a comeback interval based on the memory access pattern may be stored in a remote memory group corresponding to the comeback interval when the remote memory group corresponding to the comeback interval has a storage space capable of accommodating the specific memory page.

In some embodiments of the present disclosure, a specific memory page determined to correspond to a remote memory group corresponding to a comeback interval based on the memory access pattern may be stored in one remote memory group that has a storage space capable of accommodating the specific memory page among at least one remote memory group corresponding to a fast access speed compared to the remote memory group corresponding to the comeback interval when the remote memory group corresponding to the comeback interval does not have the storage space capable of accommodating the specific memory page.

In some embodiments of the present disclosure, the one remote memory group may correspond to a remote memory group having a storage space capable of accommodating the specific memory page while corresponding to the slowest access speed among the at least one remote memory group.

In some embodiments of the present disclosure, a specific memory page determined to correspond to a remote memory group corresponding to a comeback interval based on the memory access pattern may be stored in one remote memory group that has a storage space capable of accommodating the specific memory page among at least one remote memory group corresponding to a slow access speed compared to the remote memory group corresponding to the comeback interval when there is no remote memory group having the storage space capable of accommodating the specific memory page among the remote memory group corresponding to the comeback interval and at least one remote memory group corresponding to a fast access speed compared to the remote memory group corresponding to the comeback interval.

In some embodiments of the present disclosure, the one remote memory group may correspond to a remote memory group having a storage space capable of accommodating the specific memory page while corresponding to the fastest access speed among the at least one remote memory group.

In some embodiments of the present disclosure, for a specific memory page determined to correspond to a remote memory group corresponding to a comeback interval based on the memory access pattern, when there is no remote memory group having a storage space capable of accommodating the specific memory page among the remote memory group corresponding to the comeback interval, at least one remote memory group corresponding to a fast access speed compared to the remote memory group corresponding to the comeback interval and at least one remote memory group corresponding to a slow access speed compared to the remote memory group corresponding to the comeback interval, the specific memory page may be maintained in a local memory.

In some embodiments of the present disclosure, a remote memory group corresponding to a comeback interval based on the memory access pattern corresponds to an ideal remote memory group, and when a specific memory page determined to correspond to the ideal remote memory group is stored in a remote memory group slower than the ideal remote memory group, migration of the specific memory page to the ideal remote memory group may be pushed.

In some embodiments of the present disclosure, when a specific memory page where a remote memory group corresponding to a comeback interval based on the memory access pattern is determined to correspond to an ideal remote memory group is stored in a remote memory group slower than the ideal remote memory group, migration of the specific memory page to the ideal remote memory group may be performed when the ideal remote memory group has a storage space.

In some embodiments of the present disclosure, when a specific memory page determined to correspond to an ideal remote memory group corresponding to a comeback interval based on the memory access pattern is stored in a remote memory group faster than the ideal remote memory group, migration of the specific memory page to the ideal remote memory group or the remote memory faster than the ideal remote memory may be pushed.

In some embodiments of the present disclosure, when a specific memory page where a remote memory group corresponding to a comeback interval based on the memory access pattern is determined to correspond to an ideal remote memory group is stored in a remote memory group faster than the ideal remote memory group, migration of the specific memory page may be performed when the ideal remote memory group or the remote memory faster than the ideal remote memory (but, lower than a stored remote memory) has a storage space.

The features briefly summarized above with respect to the present disclosure are just an exemplary aspect of a detailed description of the present disclosure described below, and do not limit a scope of the present disclosure.

According to the present disclosure, a method for optimizing data arrangement for a memory layer and an apparatus for the same may be provided.

According to the present disclosure, a method for optimizing a memory bandwidth and latency for a memory layer and an apparatus for the same may be provided.

According to the present disclosure, a method for generating and managing a remote memory group according to a memory bandwidth and latency and an apparatus for the same may be provided.

According to the present disclosure, a method for deriving data migration based on latency between remote memory groups and an apparatus for the same may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIGS. 1(a)-1(c) are diagrams for describing examples related to a histogram for a comeback interval according to the present disclosure.

FIG. 2 is a diagram for describing an example of an operation for storage in a remote memory when evicting a memory page according to the present disclosure.

FIG. 3 is a diagram for describing an example of an operation for determining a remote memory group according to the present disclosure.

FIG. 4 is a diagram for describing an example of an operation for reading from a remote memory when a memory page is accessed according to the present disclosure.

FIG. 5 is a diagram for describing an example of an operation when a migration thread is pushed according to the present disclosure.

FIG. 6 is a diagram for describing an example of the structure of a multi-level disaggregated memory management apparatus according to the present disclosure.

FIG. 7 is a diagram for describing an example of a multi-level disaggregated memory management method according to the present disclosure.

FIG. 8 represents an example of the block diagram of a multi-level disaggregated memory management apparatus according to the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiments without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of “and/or” includes a combination of a plurality of relevant described items or any item of a plurality of relevant described items.

When an element in the present disclosure is referred to as being "connected” or "linked" to another element, it should be understood that it may be directly connected or linked to that another element, but there may be another element between them. Meanwhile, when an element is referred to as being "directly connected” or "directly linked" to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as "include" or "have", etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The present disclosure describes a method for analyzing a memory access pattern by utilizing comeback interval information in a multi-level disaggregated memory environment. In addition, the present disclosure describes a method for optimizing a memory bandwidth and latency by arranging data in an optimal memory layer based on a memory access pattern.

The rapid development of high performance computing (HPC) and data center environments accompanies a demand for processing an increasing amount of data and complex operations. In these environments, a memory system may act as a significant bottleneck in processing performance, and accordingly, the need for a faster and more efficient memory management technology is emerging. In addition, since it is difficult to meet this demand with a single memory layer, the need for a multi-level memory hierarchy beyond the existing single memory hierarchy is emerging to meet this demand. A multi-level memory technology aims to optimize system performance and provide scalability by combining memory layers with a variety of access speeds and characteristics.

A multi-level memory hierarchy plays a critical role in balancing memory access speed and capacity. Dynamic random access memory (DRAM) provides a fast access speed but has limited capacity, and solid state drive (SSD) may store massive data but has a slow access speed. A system may simultaneously optimize capacity and speed by connecting these various memory layers through a technology such as Compute Express Link (CXL). It allows a high-performance computing system to more efficiently manage memory resources and meet increasing data processing demands.

The recent hardware development of memory technologies has enabled the realization of a multi-level disaggregated memory structure. In particular, the introduction of a high-speed interconnect technology such as CXL has significantly improved a data transmission speed between a central processing unit (CPU) and a memory. Hardware such as a CXL switch may provide support to efficiently manage and transfer data between various memory layers, thereby increasing system flexibility and scalability. A CXL technology combines various memory layers such as local DRAM, remote DRAM and SSD into one integrated memory pool, opening a new possibility for overcoming limitations in memory access time and bandwidth.

Here, there are several technical problems in the effective implementation of a multi-level memory hierarchy. In particular, a critical challenge is to minimize latency between each memory layer. For example, a remote memory connected through a CXL may have longer latency than local DRAM, which may negatively impact the overall system performance. A new access method for managing this latency and optimizing and using a variety of memory layers is needed.

In the present disclosure, a time interval when a memory page is accessed again in a multi-level disaggregated memory structure is defined as a comeback interval. For example, a memory page may correspond to a unit of a predetermined size in which data is accessed in a memory. A comeback interval may correspond to the length of time between a time point when a specific memory page is accessed and a time point when a corresponding specific page is accessed again. More specifically, a time interval from when a specific memory page is evicted to a remote memory (i.e., initially stored in a remote memory) until it is accessed again may be referred to as a comeback interval. The scope of the present disclosure is not limited by a term called comeback interval, and examples of the present disclosure may also be applied to a time interval under an arbitrary name corresponding to the definition/example of the above-described comeback interval.

The present disclosure also describes a method for analyzing a memory access pattern by utilizing comeback interval information. Furthermore, the present disclosure also describes a method for arranging/allocating data in an optimal memory layer based on a memory access pattern. Accordingly, according to various examples of the present disclosure, a memory bandwidth and latency may be optimized and system performance may be improved. It may reduce a memory management bottleneck in a high-performance computing system and construct a more efficient and scalable memory system. In particular, a significant result may be expected as a method for effectively utilizing a CXL memory in a high-performance computing application such as a large language model.

In the examples of the present disclosure, a histogram for a comeback interval may be constructed by measuring a comeback interval which corresponds to a time interval between a time point when a memory page is evicted to a remote memory and a time point when it is accessed again. Based on a comeback interval histogram, a memory page with a short comeback interval, i.e., a page which frequently goes back and forth between a local memory and a remote memory, may be located in a fast remote memory and a memory page with a long comeback interval may be located in a slow remote memory. In this way, comeback interval information may be utilized to arrange a memory page in an optimal memory layer, thereby optimizing performance on a multi-level disaggregated memory.

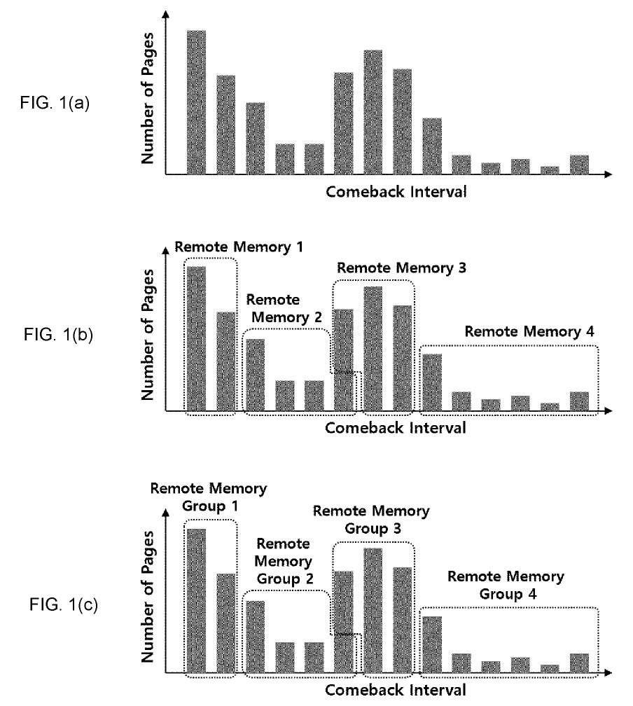

FIGS. 1(a)-1(c) are diagrams for describing examples related to a histogram for a comeback interval according to the present disclosure.

FIG. 1(a) represents an example of a histogram for a comeback interval.

For example, a histogram constructed by using comeback interval information recorded each time a memory page is evicted to a remote memory is illustrated in the form of a bar graph. Each bar represents the number of memory pages corresponding to a specific comeback interval value or the range of a specific comeback interval value.

While only the number of memory pages is shown on a histogram, the identification information of a memory page corresponding to a corresponding comeback interval value/range may be stored and updated. In other words, the number of memory pages corresponding to a specific comeback interval value/range and the identification information of a corresponding memory page may be managed together.

For example, it may be assumed that the height of a bar graph corresponds to the number of memory pages having a corresponding comeback interval value, the bottommost of a bar graph corresponds to a memory page with the lowest index of identification information among those memory pages, the uppermost of a bar graph corresponds to a memory page with the highest index of identification information among those memory pages and a location on a bar corresponds to a memory page in that order.

Alternatively, it may be assumed that the height of a bar graph corresponds to the number of memory pages having the range of a corresponding comeback interval value, the bottommost of a bar graph corresponds to a memory page with the shortest comeback interval value within the range among those memory pages, the uppermost of a bar graph corresponds to a memory page with the longest comeback interval value within the range among those memory pages and a location on a bar corresponds to a memory page in that order.

FIG. 1(b) represents an example in which a remote memory is mapped/applied based on a comeback interval.

For example, after a remote memory is ordered according to an access speed, an appropriate remote memory may be selected based on a location on a comeback interval histogram for a memory page. For example, it may be assumed that a remote memory consists of four remote memories and the order is remote memory 1, remote memory 2, remote memory 3 and remote memory 4 in descending order of access speed for remote memory. In this case, memory page(s) with a short comeback interval, i.e., page(s) that frequently goes back and forth between a local memory and a remote memory, may be located in remote memory 1 with a fast access speed and memory page(s) with a long comeback interval may be located in remote memory 4 with a slow access speed.

For an example where a portion of a bar graph corresponding to a specific comeback interval value/range is located in remote memory 2 and the remaining portion is located in remote memory 3, some memory page(s) having a low index of identification information (or a short comeback interval) among the memory pages corresponding to a corresponding bar may be allocated to remote memory 2 and some other memory page(s) having a high index of identification information (or a long comeback interval) among the memory pages corresponding to a corresponding bar may be allocated to remote memory 3.

FIG. 1(b) represents an example in which a remote memory group is mapped/applied based on a comeback interval.

For example, remote memories may be classified into at least one group based on an access speed. At least one remote memory with the same or similar access speed may belong to one remote memory group. Accordingly, a group ID corresponding to an access speed value (or a range thereof) may be allocated to each remote memory group. As the value of a group ID is lower, it may correspond to a faster access speed value/range and as the value of a group ID is higher, it may correspond to a slower access speed value/range.

Based on the group ID of a remote memory group, an appropriate remote memory may be selected according to a location on a comeback interval histogram for a memory page. For example, it may be assumed that a remote memory consists of four remote memory groups and the order is remote memory group 1, remote memory group 2, remote memory group 3 and remote memory group 4 in descending order of access speed for a remote memory group. In this case, memory page(s) with a short comeback interval, i.e., page(s) that frequently goes back and forth between a local memory and a remote memory, may be located in remote memory group 1 with a fast access speed and memory page(s) with a long comeback interval may be located in remote memory group 4 with a slow access speed.

For an example where a portion of a bar graph corresponding to a specific comeback interval value/range is located in remote memory group 2 and the remaining portion is located in remote memory group 3, some memory page(s) having a low index of identification information (or a short comeback interval) among the memory pages corresponding to a corresponding bar may be allocated to remote memory group 2 and some other memory page(s) having a high index of identification information (or a long comeback interval) among the memory pages corresponding to a corresponding bar may be allocated to remote memory group 3.

In examples described above, when a memory page is initially stored or is already stored in a remote memory (group) slower than a remote memory or a remote memory group (hereinafter, referred to as a remote memory (group)) corresponding to its comeback interval, as shown in an example described below, a migration thread may be pushed to cause a corresponding memory page to be migrated to a remote memory (group) corresponding to (e.g., faster than) the comeback interval of a corresponding memory page.

Hereinafter, a remote memory group is described in more detail.

When multiple remote memories are used to configure a remote memory, they may be grouped together when an access speed difference between remote memories is within a% (e.g., a=10). A remote memory group may be used as a unit for comeback interval-based memory page allocation. For example, in determining a target to which a memory page corresponds/will be allocated based on a comeback interval, a remote memory group may be treated as one remote memory.

After a remote memory group is generated, a group ID may be assigned according to the order of memory access speed among the groups. According to group ID assignment for a remote memory group, a memory page with a low rank among the memory pages may correspond to a remote memory group with a low group ID among the remote memory groups.

An example in which a rank according to the comeback interval of a memory page is assigned from remote memory group 0 to remote memory group n is as follows.

Remote Memory Group 0: Greater than 0 and less than or equal to sum0 (0, sum0)

Remote Memory Group 1: Greater than sum0 and less than or equal to sum1 (sum0, sum1)

Remote Memory Group 2: Greater than sum1 and less than or equal to sum2 (sum1, sum2)

...

Remote Memory Group n: Greater than sum(n-1) and less than or equal to sum n (sum(n-1),sum n)

Here, sum x corresponds to the number of memory pages stored in the corresponding remote memory.

In addition, a function for finding a remote memory group according to the rank of a memory page, i.e., a function (e.g., RANK_TO_GROUP(r)) for returning a remote memory group including corresponding rank r (or corresponding to rank r) when r, the rank value of a memory page, is input, may also be defined.

A memory page may be arranged/stored in a remote memory group according to the following policy. In examples below, it is assumed that the nth (n=0, 1, ..., N) remote memory group corresponds to group ID n and corresponds to a faster remote memory group as a value of n is lower.

Select the nth remote memory group corresponding to the pth memory page rank

When the nth remote memory group has a space to accommodate the pth memory page, store the pth memory page in the nth remote memory group

When the nth remote memory group does not have a space to accommodate the pth memory page, attempt to sequentially store the pth memory page in the n-1th remote memory group to the 0th remote memory group (i.e., after checking whether there is a space to accommodate the pth memory page, if so, store it).

When the n-1th remote memory group to the 0th remote memory group do not have a space to accommodate the pth memory page, attempt to sequentially store from the n+1th remote memory group to the Nth remote memory group (i.e., after checking whether there is a space to accommodate the pth memory page, if so, store it).

When the pth memory page is stored in one of the n+1th remote memory group to the Nth remote memory group, a migration thread may be pushed.

Hereinafter, remote memory migration is described.

It is assumed that a remote memory group corresponding to the rank of the pth memory page is the nth memory group.

If the pth memory page is stored in one of the n+1th remote memory group to the Nth remote memory group, migration to the nth remote memory group may be attempted.

If the kth memory page is stored in one of the n-1th remote memory group to the 0th remote memory group, it may be maintained in a current remote memory group or migration to the nth remote memory group may be attempted. It is to optimize the overall system performance by attempting to migrate to the nth remote memory group (ideally) corresponding to the rank of the kth memory page since when the kth memory page is stored in a remote memory group faster than the nth remote memory group, it may cause a migration push to another memory page (corresponding to a lower comeback interval).

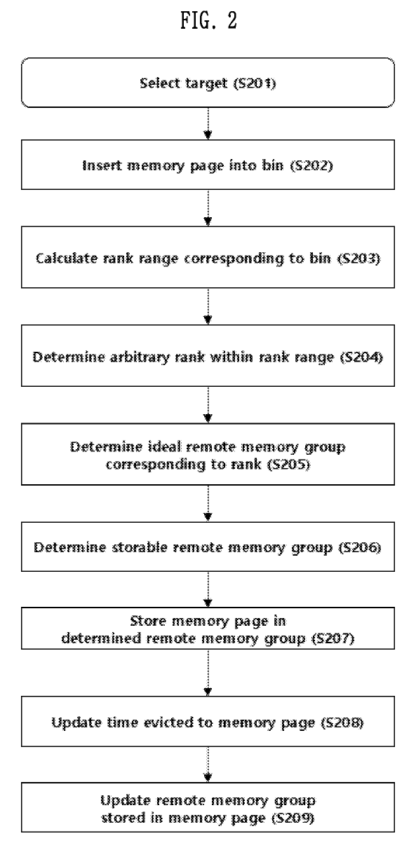

FIG. 2 is a diagram for describing an example of an operation stored in a remote memory when evicting a memory page according to the present disclosure.

When a memory page is selected as a target to be evicted S201, it may be inserted into the bin of a histogram (e.g., BINₖ) corresponding to the comeback interval of a corresponding memory page S202. A rank range corresponding to a bin (BINₖ) into which a memory page is inserted may be calculated S203. For example, a rank range may be calculated as (sum(BIN₁:BINₖ₋₁), sum(BIN₁:BINₖ)). An arbitrary rank r may be determined within a corresponding rank range S204. For example, a rank range may correspond to (rank_rangeₘᵢₙ, rank_rangeₘₐₓ), and one rank r among them may be randomly determined according to rand(rank_rangeₘᵢₙ, rank_rangeₘₐₓ).

When a rank is assigned, an ideal remote memory group (g_{ideal}) corresponding to an assigned rank r may be found S205. For example, it may be expressed as g_{ideal}= RANK_TO_GROUP(r). Next, starting from a determined ideal remote memory group, a remote memory group (g) capable of storing a memory page may be found S206.

When a remote memory group (g) capable of storing a memory page exists, a memory page may be stored in a corresponding remote memory group (g) S207. When a memory page is stored in a remote memory group, the eviction time of a memory page (e.g., to a current time point (now)) may be updated in a memory page S208, and a remote memory group (e.g., g) where a memory page is stored may be stored in a memory page S209.

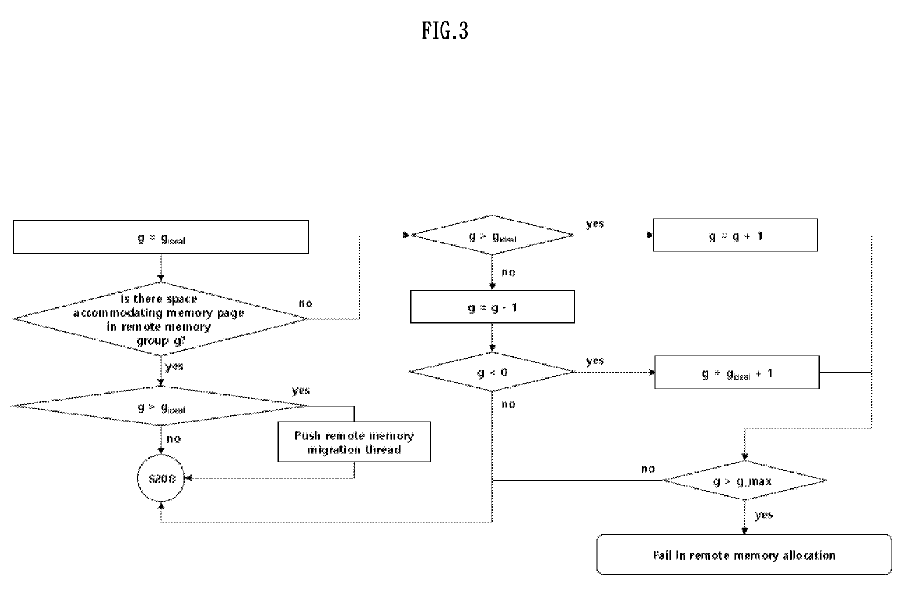

FIG. 3 is a diagram for describing an example of an operation for determining a remote memory group according to the present disclosure.

Steps in FIG. 3 may correspond to substeps of S206 in FIG. 2. For example, when a selected ideal remote memory group (g_{ideal}) has no space, it may be possible to attempt to first store a memory page in one of the faster remote memory groups. If all of the faster remote memory groups have no space, it may be possible to attempt to store a memory page in one of the slower remote memory groups. If all of the slower remote memory groups have no space, remote memory allocation fails and an operation terminates. If stored in a slower remote memory group, a migration thread may be pushed.

In the present disclosure, when a memory page is arranged/stored in a remote memory group, when a remote memory group includes a plurality of remote memories, a memory page may be arranged/stored in one arbitrary remote memory among a plurality of remote memories, or a plurality of remote memories in a distributed way, or one remote memory with the lowest (or highest) index among a plurality of remote memories having a sufficient space.

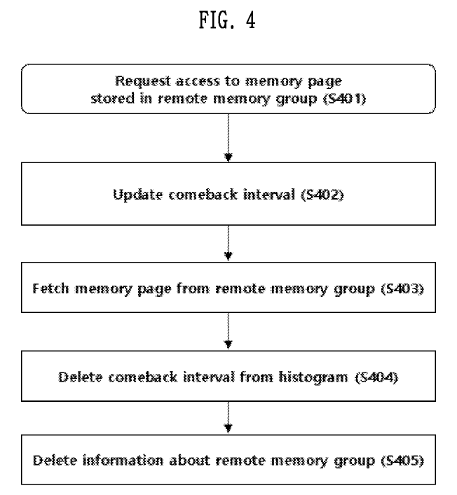

FIG. 4 is a diagram for describing an example of an operation for reading from a remote memory when a memory page is accessed according to the present disclosure.

It is assumed that an access request occurs for a memory page stored in a remote memory (or a remote memory group) S401. In this case, the comeback interval of a corresponding memory page may be calculated and stored in a corresponding memory page S402. For example, a new comeback interval may be updated according to a difference value between the evict timer stored in a corresponding memory page and the current time (now) and the average of previously stored comeback intervals.

Afterwards, a memory page may be fetched from a remote memory group S403. In addition, a comeback interval allocated to a memory page may be deleted from a histogram S404. In addition, information about a remote memory group may be deleted from a memory page S405. For example, a remote memory group variable stored in a memory page may be set as none, and an ideal remote memory group variable may also be set as none.

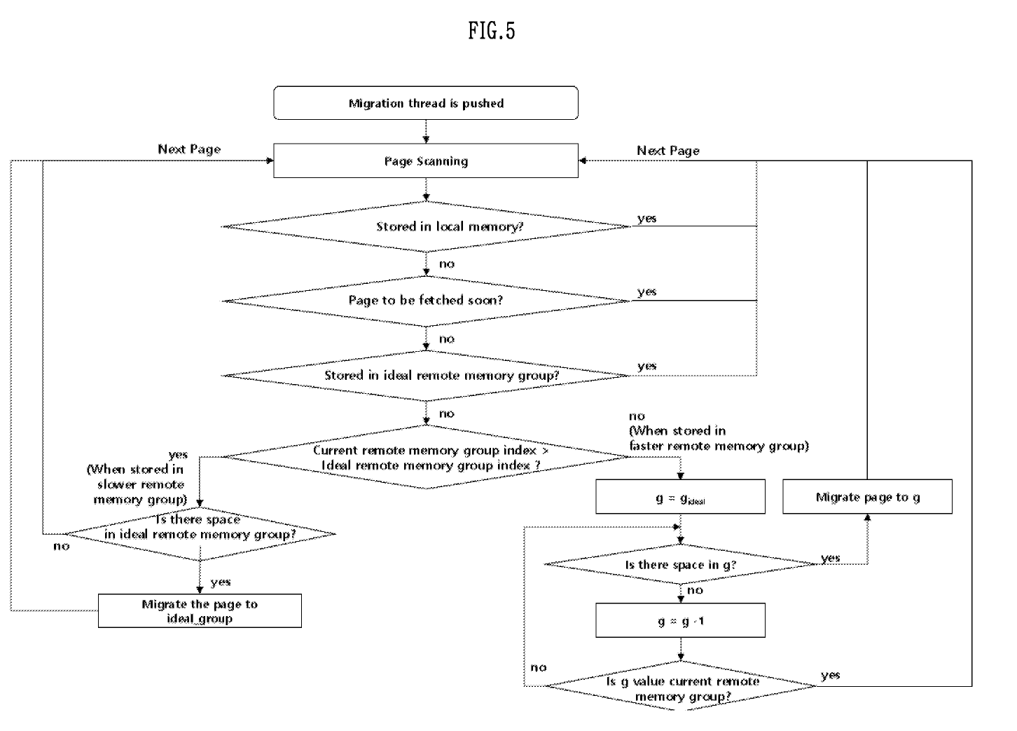

FIG. 5 is a diagram for describing an example of an operation when a migration thread is pushed according to the present disclosure.

The example of FIG. 5 represents a flowchart in which a migration thread performs migration on memory pages in remote memory groups when a migration thread is pushed. A migration thread may be pushed when a memory page is stored in a slower remote memory group because an ideal remote memory group has no storage space.

Through page scanning, the storage status of each memory page may be confirmed. When a page is stored in a local memory, the next page is scanned.

When a page is not stored in a local memory, it may be determined whether it is expected to be fetched soon. For example, when the comeback interval of a memory page is greater than a value obtained by subtracting the evict time of a memory page from the current time, it may be determined that a memory page is expected to be fetched soon. When it is expected to be fetched soon, the next memory page is scanned.

When it is not expected to be fetched soon, it may be determined whether a remote memory group where a corresponding page is stored is an ideal remote memory group. When it is stored in an ideal remote memory group, the next memory page is scanned.

When it is not stored in an ideal remote memory group, it may be determined whether the index of a currently stored remote memory group is greater than the index of an ideal remote memory group.

If so, i.e., if it is stored in a slower remote memory group, whether an ideal remote memory group has a storage space may be confirmed, and if so, a memory page may be migrated to an ideal remote memory group. After migration, the next memory page may be scanned.

If not, i.e., if it is stored in a faster remote memory group, migration to a remote memory group with a storage space may be performed after confirming whether there is a storage space in order from an ideal remote memory group to a current remote memory group. After migration, the next memory page may be scanned.

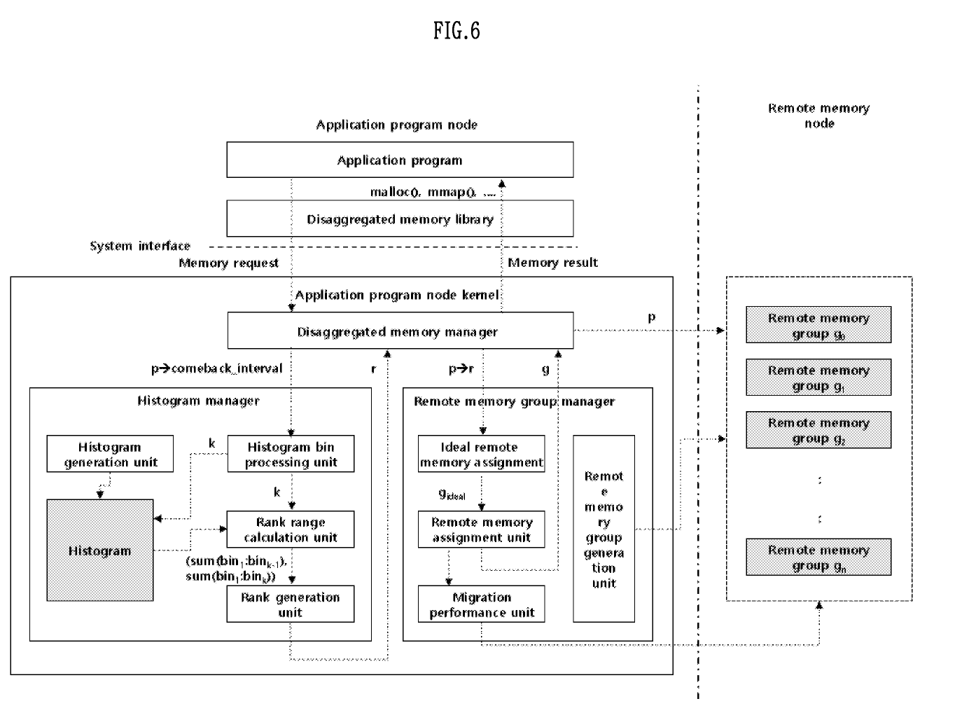

FIG. 6 is a diagram for describing an example of the structure of a multi-level disaggregated memory management apparatus according to the present disclosure.

FIG. 6 represents the structure of a method and an apparatus for the efficient arrangement and performance optimization of a multi-level disaggregated memory utilizing comeback interval information in a disaggregated memory system.

A disaggregated memory manager manages whether the memory of an application program exists in a local memory or a remote memory, and when an application program accesses a specific memory, data existing in a remote memory may be moved (e.g., fetched) to a local memory and mapped to a local memory so that a corresponding process may access it.

A histogram manager may include a histogram generation unit that initializes and generates a histogram, a histogram bin processing unit that receives the comeback interval of a memory page (p) as an input to calculate a bin index k for a histogram and increases the value of the kth bin of a histogram, a rank range calculation unit that receives a bin index k as an input to calculate a rank range that a memory page may have (e.g., (sum(BIN₁:BINₖ₋₁), sum(BIN₁:BINₖ)) and a rank generation unit that receives a rank range as an input to generate the rank value r of a memory page within a rank range.

A remote memory group manager may include a remote memory group generation unit that generates a remote memory group by using multiple remote memories and assigns a group ID for a generated remote memory group when configuring a remote memory, an ideal remote memory assignment unit that receives the rank value r of a memory page as an input to assign an ideal remote memory group, a remote memory assignment unit that finds a remote memory group having a space to store a memory page from an ideal remote memory group and a migration performance unit that performs migration when an assigned remote memory group corresponds to a remote memory group slower than an ideal remote memory group.

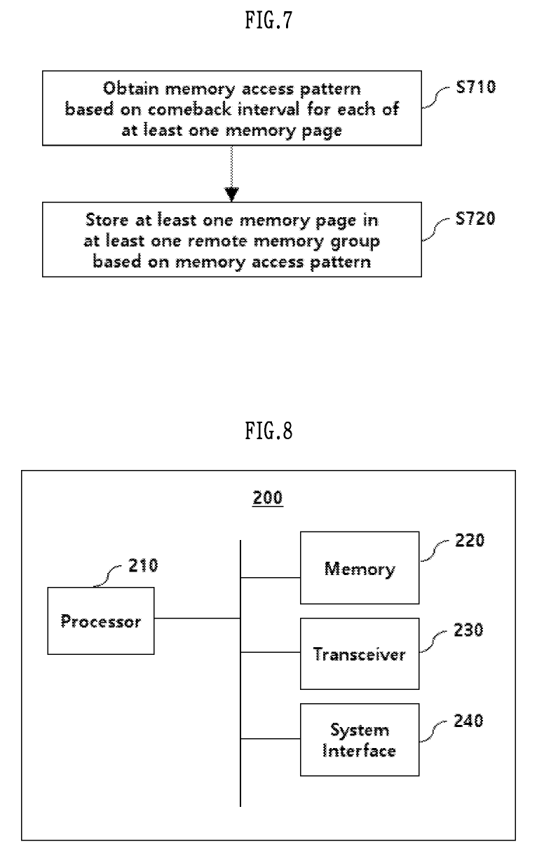

FIG. 7 is a diagram for describing an example of a multi-level disaggregated memory management method according to the present disclosure.

In S710, an apparatus may obtain a memory access pattern based on a comeback interval for each of at least one memory page.

In some examples, a comeback interval may correspond to a time interval from a time point when a specific memory page is evicted to a remote memory group to a time point when a specific memory page is accessed (e.g., fetched). If access to a specific memory page occurs, a comeback interval for a specific memory page may be updated.

In some examples, a memory access pattern may be determined based on a histogram for a comeback interval for each of at least one memory page.

In S720, an apparatus may store at least one memory page in at least one remote memory group based on a memory access pattern.

In some examples, one remote memory group may include one remote memory or a plurality of remote memories. In addition, a group ID corresponding to an access speed may be allocated to each remote memory group.

In some examples, an operation for storing a specific memory page (stored in a local memory) in a remote memory group may be performed as follows.

First, based on a memory access pattern for a specific memory page, it may be determined that a specific memory page corresponds to the first remote memory group (e.g., an ideal remote memory group). Accordingly, when the first (ideal) remote memory group has a storage space capable of accommodating a specific memory page, a specific memory page may be stored in the first (ideal) remote memory group.

If the first (ideal) remote memory group does not have a storage space capable of accommodating a specific memory page, a specific memory page may be stored in one remote memory group having a storage space capable of accommodating a specific memory page among at least one remote memory group corresponding to a fast access speed compared to the first (ideal) remote memory group. Here, one remote memory group where a specific memory page is stored may correspond to a remote memory group having a sufficient storage space after confirmation in ascending order of access speed among at least one remote memory group (corresponding to a fast access speed compared to the first (ideal) remote memory group).

If the first (ideal) remote memory group and at least one remote memory group corresponding to a fast access speed do not have a storage space capable of accommodating a specific memory page, a specific memory page may be stored in one remote memory group having a storage space capable of accommodating a specific memory page among at least one remote memory group corresponding to a slow access speed compared to the first (ideal) remote memory group. Here, one remote memory group where a specific memory page is stored may correspond to a remote memory group having a sufficient storage space after confirmation in descending order of access speed among at least one remote memory group (corresponding to a slow access speed compared to the first (ideal) remote memory group).

If all remote memory groups do not have a storage space capable of accommodating a specific memory page, a specific memory page may be maintained in a local memory.

In some examples, an operation in which a specific memory page stored in an arbitrary remote memory group is migrated to another remote memory group may be performed as follows.

First, based on a memory access pattern for a specific memory page, it may be determined that a specific memory page corresponds to the first remote memory group (e.g., an ideal remote memory group). It may be assumed that such a specific memory page is currently stored in a remote memory group other than the first (ideal) remote memory group.

If a specific memory page is stored in the second remote memory group (e.g., a remote memory group corresponding to a slow access speed compared to the first (ideal) remote memory group), the migration of a specific memory page to the first (ideal) remote memory group may be pushed.

If a specific memory page is stored in the third remote memory group (e.g., a remote memory group corresponding to a fast access speed compared to the first (ideal) remote memory group), the migration of a specific memory page to the fourth remote memory group (e.g., a remote memory group corresponding to a slow access speed compared to the third remote memory group) or the first (ideal) remote memory group may be pushed. More specifically, among the first (ideal) remote memory group and at least one remote memory group corresponding to a faster access speed than the first (ideal) remote memory group, a remote memory group corresponding to the slowest access speed and having a storage space capable of accommodating a specific memory page may be determined as the fourth remote memory group.

FIG. 8 represents an example of the block diagram of a multi-level disaggregated memory management apparatus according to the present disclosure.

A multi-level disaggregated memory management apparatus 200 may include at least one processor 210, at least one memory 220, at least one transceiver 230, at least one system interface 240, etc. A memory 220 may be included in a processor 210 or may be configured separately. A memory 220 may store an instruction that causes an apparatus 200 to perform an operation when executed by a processor 210. A transceiver 230 may transmit and/or receive a signal, data, etc. that is exchanged by an apparatus 200 with other entities. A system interface 240 may receive a system (e.g., OS) input for an apparatus 200 or provide the output of an apparatus 200 to a system. Among the components of an apparatus 200, components other than a processor 210 and a memory 220 may not be included in some cases, and other components not shown in FIG. 8 may be included in an apparatus 200.

A processor 210 may be configured to cause an apparatus 200 to perform the operation of an apparatus according to various examples of the present disclosure. Although not illustrated in FIG. 8, a processor 210 may be configured as a set of modules that performs each function. A module may be configured in the form of hardware and/or software.

A memory 220 corresponds to a local memory and may be distinguished from a remote memory (group). A remote memory (group) is not illustrated in FIG. 8. For example, a processor 210 may access a remote memory (group) through a transceiver 210. For example, a processor 210 may evict a memory page stored in a local memory 220 to a remote memory (group) through a transceiver 210 or may fetch a memory page from a remote memory (group) through a transceiver 210 and store it in a local memory 220.

A system interface 240 may correspond to an interface that may exchange requests/responses/indications/reports between a multi-level disaggregated memory management apparatus 200 and an operating system. For example, a system interface 240 may also be referred to as a system call interface. For example, a multi-level disaggregated memory management apparatus 200 may receive a memory request from an application program node through a system interface 240 and transmit a memory result to an application program node through a system interface 240.

For example, a processor 210 may be configured to obtain a memory access pattern based on a comeback interval for each of at least one memory page, and transmit, through at least one transceiver 230, at least one memory page to be stored in at least one remote memory group based on a memory access pattern.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by software and software may be recorded in a recording medium. A component, a function and a process described in illustrative embodiments may be implemented by a combination of hardware and software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, computer hardware, firmware, software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A multi-level disaggregated memory management method, the method comprising:
obtaining a memory access pattern based on a comeback interval for each of at least one memory page; and
storing the at least one memory page in at least one remote memory group based on the memory access pattern.

2. The method of claim 1, wherein:
the comeback interval corresponds to a time interval from a time point when a specific memory page is evicted to a remote memory group to a time point when the specific memory page is accessed.

3. The method of claim 1, wherein:
the memory access pattern is determined based on a histogram for the comeback interval for the each of the at least one memory page.

4. The method of claim 1, wherein:
the remote memory group includes one remote memory or a plurality of remote memories, and
a group ID corresponding to an access speed is allocated to each of the remote memory groups.

5. The method of claim 1, wherein:
when an access occurs to a specific memory page among the at least one memory page, a comeback interval for the specific memory page is updated.

6. The method of claim 1, wherein:
a specific memory page determined to correspond to a remote memory group corresponding to a comeback interval based on the memory access pattern is stored in the remote memory group corresponding to the comeback interval when the remote memory group corresponding to the comeback interval has a storage space capable of accommodating the specific memory page.

7. The method of claim 1, wherein:
a specific memory page determined to correspond to a remote memory group corresponding to a comeback interval based on the memory access pattern is stored in one remote memory group having a storage space capable of accommodating the specific memory page among at least one remote memory group corresponding to a fast access speed compared to the remote memory group corresponding to the comeback interval when the remote memory group corresponding to the comeback interval does not have the storage space capable of accommodating the specific memory page.

8. The method of claim 7, wherein:
the one remote memory group corresponds to a remote memory group that has the storage space capable of accommodating the specific memory page while corresponding to a slowest access speed among the at least one remote memory group.

9. The method of claim 1, wherein:
a specific memory page determined to correspond to a remote memory group corresponding to a comeback interval based on the memory access pattern is stored in one remote memory group having a storage space capable of accommodating the specific memory page among at least one remote memory group corresponding to a slow access speed compared to the remote memory group corresponding to the comeback interval when there is no remote memory group having the storage space capable of accommodating the specific memory page among the remote memory group corresponding to the comeback interval and at least one remote memory group corresponding to a fast access speed compared to the remote memory group corresponding to the comeback interval.

10. The method of claim 9, wherein:
the one remote memory group corresponds to a remote memory group that has the storage space capable of accommodating the specific memory page while corresponding to a fastest access speed among the at least one remote memory group corresponding to the slow access speed.

11. The method of claim 1, wherein:
for a specific memory page determined to correspond to a remote memory group corresponding to a comeback interval based on the memory access pattern, when there is no remote memory group having a storage space capable of accommodating the specific memory page among the remote memory group corresponding to the comeback interval, at least one remote memory group corresponding to a fast access speed compared to the remote memory group corresponding to the comeback interval, and at least one remote memory group corresponding to a slow access speed compared to the remote memory group corresponding to the comeback interval, the specific memory page is maintained in a local memory.

12. The method of claim 1, wherein:
when a specific memory page determined to correspond to a remote memory group corresponding to a comeback interval based on the memory access pattern is stored in a slower remote memory group, a migration of the specific memory page to the remote memory group corresponding to the comeback interval is pushed.

13. The method of claim 12, wherein:
the remote memory group corresponding to the comeback interval corresponds to an ideal remote memory group, and
the slower remote memory group in which the specific memory page is currently stored corresponds to a slow access speed compared to the remote memory group corresponding to the comeback interval.

14. The method of claim 1, wherein:
when a specific memory page determined to correspond to a remote memory group corresponding to a comeback interval based on the memory access pattern is stored in a faster remote memory group, a migration of the specific memory page to the remote memory group corresponding to the comeback interval or a fast remote memory group is pushed.

15. The method of claim 14, wherein:
the remote memory group corresponding to the comeback interval corresponds to an ideal remote memory group, and
the faster remote memory group in which the specific memory page is currently stored corresponds to a fast access speed compared to the ideal remote memory group.

16. The method of claim 15, wherein:
the fast remote memory group corresponds to a slow access speed compared to the faster remote memory group.

17. The method of claim 16, wherein:
the fast remote memory group corresponds to a remote memory group that has a storage space capable of accommodating the specific memory page while corresponding to a slowest access speed among the ideal remote memory group and at least one remote memory group corresponding to a faster access speed than the ideal remote memory group.

18. A multi-level disaggregated memory management apparatus, the apparatus comprising:
at least one transceiver;
at least one system interface; and
at least one processor,
wherein the at least one processor is configured to:
obtain a memory access pattern based on a comeback interval for each of at least one memory page; and
transmit, through the at least one transceiver, the at least one memory page to be stored in at least one remote memory group based on the memory access pattern.

19. A processing unit for managing a multi-level disaggregated memory, the processing unit comprising:
at least one processor; and
at least one local memory that is operably connected to the at least one processor, and based on being executed by the at least one processor, stores instructions for performing:
an operation for obtaining a memory access pattern based on a comeback interval for each of at least one memory page; and
an operation for allocating the at least one memory page to at least one remote memory group based on the memory access pattern.
